(19) United States
(12) Patent Application Publication
(10) Pub. No.: US 2011/0244191 A1
(43) Pub. Date: Oct. 6, 2011

(54) WOOD CEMENT BOARD AND PRODUCTION METHOD THEREOF

(76) Inventors: Fumihiro ASAKURA, Nagoya-shi (JP); Yoshinori Hibino, Ama-gun (JP)

(21) Appl. No.: 13/049,985

(22) Filed: Mar. 17, 2011

(30) Foreign Application Priority Data
Mar. 31, 2010 (JP) JP2010-083174

(51) Int. Cl. B32B 3/30; B32B 5/26

(52) U.S. Cl. 428/172; 156/62.8

(57) ABSTRACT

A wood cement board having on a surface thereof a rugged pattern has a plurality of layers laminated each having a cement, a silica-containing material, wood fibers and wood flour, wherein the cement and the silica-containing material are contained at a weight ratio ranging from 3:7 to 7:3, the wood flour ranges in size from 0.3 to 1.5 mm and is covered with calcium, and the amount of the wood fibers and the wood flour is not greater than 9 wt % with respect to total solids. Also provided is a method of producing a wood cement board, comprising the steps of covering wood flour ranging in size from 0.3 to 1.5 mm with calcium by mixing the wood flour with a cement composition, or with a cement, or with water resulting from dewatering a slurry, and stirring the mixture in water at a predetermined solids concentration; producing a slurry; producing a laminated mat; and pressing the mat at a pressure not higher than 10 MPa in use of a press, forming thereby a rugged pattern and performing curing.

### BACKGROUND OF THE INVENTION

1. Field of the Invention

The present invention relates to a wood cement board suitable as a construction board, and to a method of producing the wood cement board.

2. Description of the Related Art

Conventional wood cement boards have, as main components, a hydraulic inorganic powder such as a cement or the like, and wood fibers such as wood pulp fibers. Such wood cement boards have high specific gravity, and excellent properties such as flexural strength, and hence are used as construction boards in the form of, for instance, interior panel materials, siding members and the like.

Better designability, through formation of a deep rugged pattern in the surface, is required from wood cement boards. However, providing a deep rugged pattern in the surface is likely to give rise to cracks at edges, corners and pronouncedly curved portions, and is likely to result in weaker strength, and/or occurrence of warpage over long periods of time.

Such being the case, Japanese Patent Application Publication No. 2002-321212 discloses a production method that involves forming a mat through sheet-forming of a slurry that contains a hydraulic inorganic powder and wood pulp fibers; laminating the formed mat to a plurality of layers, to yield a laminated mat; pressing a formboard, having formed thereon a rugged pattern, against the surface of the laminated mat, in a state where the water content of the laminated mat ranges from 70 to 100 wt %; and pressing the laminated mat at high pressure, not lower than 15 MPa, followed by curing and hardening; to prevent as a result the occurrence of cracks at edges, corners and pronouncedly curved portions of the rugged pattern. Japanese Patent Application Publication No. 2002-321212 allows thus preventing the occurrence of cracks at edges, corners and pronouncedly curved portions of a rugged pattern. However, pressing must be carried out at high pressure, not lower than 15 MPa, and hence a high-pressure press is required, which drives up equipment costs.

### SUMMARY OF THE INVENTION

Therefore, it is an object of the present invention to provide a wood cement board that can be manufactured even at a press pressure not higher than 10 MPa, and that boasts excellent surface designability, flexural strength and long-term durability, and to provide a production method of such a wood cement board.

The present invention provides a wood cement board having on a surface thereof a rugged pattern. The wood cement board of the present invention has a plurality of layers laminated each having a cement, a silica-containing material, wood fibers and wood flour, wherein the cement and the silica-containing material are contained at a weight ratio ranging from 3:7 to 7:3; the wood flour ranges in size from 0.3 to 1.5 mm and is covered with calcium; and the content of the wood fibers and the wood flour is not greater than 9 wt % with respect to the total solids of the wood cement board. The content of the wood flour ranges from 1 to 3 wt %, more preferably from 1 to 2 wt %, with respect to the total solids of the wood cement board.

The present invention provides also a method of producing a wood cement board having a rugged pattern on a surface. The production method comprises the steps of covering wood flour with calcium; producing a slurry by mixing the thus-obtained wood flour, a cement, a silica-containing material and wood fibers; producing a formed sheet by dewatering the thus-obtained slurry; producing a laminated mat by laminating the thus-obtained formed sheet; and pressing the thus-obtained laminated mat at a pressure not higher than 10 MPa, and forming thereby a rugged pattern, followed by curing. The step of covering the wood flour with calcium may involve adding to water a pulverized material of a cement composition and wood flour, thereby being mixed at a solids concentration of 8 to 20 wt %, or adding wood flour and a cement to water thereby being mixed at a solids concentration of 3 to 10 wt %; or adding wood flour to water resulting from dewatering a slurry, thereby being mixed at a solids concentration of 3 to 10 wt %. In the step of covering wood flour with calcium there is used wood flour ranging in size from 0.3 to 1.5 mm. In the step of covering wood flour with calcium, preferably, the weight ratio of the wood flour and the cement composition is set to 1:7 to 1:20, or the cement is added to a greater amount than that of the wood flour. Preferably, the wood flour and the cement composition, or the cement, or the water resulting from dewatering a slurry, are mixed for 60 seconds or longer.

In the step of producing a slurry, the weight ratio of the cement and the silica-containing material in the slurry ranges from 3:7 to 7:3, and the amount of wood fibers and wood flour is not greater than 9 wt % with respect to total solids. Preferably, the amount of the wood flour ranges from 1 to 3 wt %, more preferably 1 to 2 wt %, with respect to the total solids of the wood cement board.

The present invention allows providing a wood cement board that can be manufactured even at a press pressure not higher than 10 MPa, and that boasts excellent surface designability, flexural strength and long-term durability, and allows providing a production method of such a wood cement board.

### DESCRIPTION OF THE PREFERRED EMBODIMENTS

Embodiments of the present invention are explained in detail below.

The wood cement board of the present invention is a laminate of a plurality of layers comprising a cement, a silica-containing material, wood fibers and wood flour.

Examples of cement include, for instance, Portland cement, high early-strength cement, alumina cement, fly ash cement, blast-furnace slag cement, silica cement, white cement or the like. In the present invention there may be contained one type alone, or two or more types, of any of the foregoing materials.

Examples of the silica-containing material include, for instance, silica sand, silica stone powder, silica flour, silica fume, fly ash, blast furnace slag, Shirasu balloons, perlite, diatomite, and the like. In the present invention there may be contained one type alone, or two or more types, of any of the foregoing materials.

Examples of wood fibers include, for instance, used paper, needle-leaves-tree unbleached kraft pulp (NUKP), needle-leaves-tree bleached kraft pulp (NBKP), laubholz unbleached kraft pulp (LUKP), laubholz bleached kraft pulp (LBKP) and the like. In the present invention there may be contained one type alone, or two or more types, of any of the foregoing materials. Preferably, wood fibers having a Canadian freeness no greater than 500 ml, refined using a beating machine such as a disc refiner or the like, are used herein, since such fibers allow enhancing properties such as strength.

The size of the wood flour ranges from 0.3 to 1.5 mm. The wood flour can be produced by crushing lumber harvested from forests, but can also be produced by crushing, for instance, thinning wood, scraps from the production of wooden posts, and other wood waste.

In the present invention, a cement composition can also be used as one of the starting materials. The cement composition may be, for instance, defective wood cement boards before hardening or defective wood cement boards after hardening, produced in a production process, as well as scraps, waste and the like of wood cement boards gathered at a construction site. All such materials are used after pulverization, in an impact mill and/or abrasion mill, to an average particle size of 50 to 150 μm.

Using the above cement composition allows reducing manufacturing costs while reducing industrial waste.

Other starting materials of the wood cement board include, for instance, hardening accelerators such as calcium chloride, magnesium chloride, potassium sulfate, calcium sulfate, magnesium sulfate, aluminum sulfate, sodium aluminate, potassium aluminate, calcium formate, calcium acetate, calcium acrylate, water glass or the like; mineral powders such as mica, bentonite, vermiculite or the like; waterproofing agents such as natural and synthetic waxes, paraffin, succinic acid, silicone or metal salts of higher fatty acids; water-repelling agents; plastic foam such as foamed thermoplastic plastic beads, chemical fibers such as nylon, polyvinyl alcohol fibers, polyester fibers, polypropylene fibers, acrylic fibers, polyurethane fibers, glass fibers or the like; an aqueous paste of polyvinyl alcohol, carboxymethylcellulose or the like; or a reinforcing agent of a synthetic resin emulsion such as an acrylic resin emulsion, a styrene-butadiene latex or the like.

The wood cement board of the present invention contains the cement and the silica-containing material at a weight ratio of 3:7 to 7:3, and contains not more than 9 wt % of wood fibers and wood flour.

That is because the wood cement board can exhibit excellent features in terms of sufficient strength and sufficient deflection, while being free of workability and nail-driving problems, if the weight ratio of the content of the cement and the silica-containing material lies within the range from 3:7 to 7:3. Outside this range, the wood cement board fails to acquire enough strength and becomes brittle. Alternatively, the specific gravity of the board increases, deflection decreases, the board becomes stiffer, heavier and difficult to transport, and becomes also problematic in terms of, for instance, workability and nail driving.

The rationale for prescribing a content of wood fibers plus wood flour no greater than 9 wt % derives from the fact that if the content of wood fibers plus wood flour exceeds 9 wt % the surface of the board fails to be sufficiently molded when pressed at a pressure not higher than 10 MPa, so that cracks are likely to develop at edges, corners and at pronouncedly curved portions of the rugged pattern. Preferably, the content of wood fibers ranges from 4 to 8 wt % and the content of wood flour from 1 to 3 wt %, since in that case the obtained wood cement board has excellent properties, such as strength, and the surface of the board is particularly superior in designability. Preferably, the content of wood flour ranges from 1 to 2 wt % with respect to total solids in the wood cement board, since excellent properties, such as strength, are achieved in that case.

The wood cement board of the present invention can be produced in accordance with a wet production method.

The production method of the present invention comprises the steps of covering wood flour with calcium; producing a slurry by mixing the obtained wood flour, a cement, a silica-containing material and wood fibers; producing a formed sheet by dewatering the obtained slurry; producing a laminated mat by laminating the obtained formed sheet; and pressing the obtained laminated mat at a pressure not higher than 10 MPa, forming thereby a rugged pattern, and performing curing.

The method of covering the wood flour with calcium may involve adding a pulverized material of a cement composition and wood flour to water, with mixing at a solids concentration of 8 to 20 wt %, or adding wood flour and a cement to water, with mixing at a solids concentration of 3 to 10 wt %, or adding wood flour to water resulting from dewatering a slurry, with mixing at a solids concentration of 3 to 10 wt %. The rationale behind prescribing the range of 8 to 20 wt % for the solids concentration in water having mixed therein a pulverized material of a cement composition and wood flour, the range of 3 to 10 wt % for the solids concentration of water having mixed therein a cement and wood flour, and the range of 3 to 10 wt % for the solids concentration of wood flour and water from a dewatered slurry is that such concentrations are suitable for covering wood flour with calcium, and are easy to work with. Specifically, although the degree of calcium leaching from a cement composition varies depending on the constituent composition, calcium leaches to a lesser degree than cement, and hence the solids concentration must be set higher than for cement. To cover wood flour with calcium, thus, the solids concentration must be higher than 8 wt %. On the other hand, fluidity becomes impaired, and work difficult, if the solids concentration exceeds 20 wt %. The solids concentration is set therefore to range from 8 to 20 wt %. Since calcium leaching from cement is greater degree than the cement composition, the solids concentration of cement need not be set higher than 10 wt %. However, a solids concentration below 3 wt % precludes the wood flour from being sufficiently covered with calcium. The solids concentration is set thus to range from 3 to 10 wt %. Water resulting from dewatering a slurry already has calcium leached thereinto, and the solids concentration need not be set higher than 10 wt %. However, a solids concentration below 3 wt % precludes the wood flour from being sufficiently covered with calcium. The solids concentration is set therefore to range from 3 to 10 wt %.

In any of the above instances, the wood flour that is used has a size ranging from 0.3 to 1.5 mm. The rationale for using wood flour having a size ranging from 0.3 to 1.5 mm is that, outside this range, the obtained wood cement board fails to exhibit adequate properties and/or surface plasticity.

The amount of wood flour with respect to the total solids of the wood cement board is 9 wt %, in combination with wood fibers, and ranges preferably from 1 to 3 wt %, more preferably from 1 to 2 wt %.

In a case where the process of covering the wood flour with calcium is performed by adding a pulverized material of a cement composition and wood flour to water, with mixing, the weight ratio of the wood flour and the cement composition ranges preferably from 1:7 to 1:20, since within that range the wood flour can be readily covered with calcium and the obtained wood cement board exhibits sufficient strength. In a case where the process of covering the wood flour with calcium is performed by adding a cement and wood flour to water, with mixing, the amount of cement is preferably greater than the amount of wood flour, since this way the wood flour can be readily covered with calcium and the obtained wood cement board exhibits sufficient strength.

The wood flour and the cement composition, or the cement, or the water resulting from dewater a slurry, are preferably mixed for 60 seconds or longer, since this way the wood flour becomes reliably covered with calcium. As regards the order in which the wood flour and the cement composition or the cement are mixed, the wood flour may be added first, or may be added last.

The subsequent process of producing a slurry involves mixing the obtained wood flour, a cement, a silica-containing material, and wood fibers. The cement, the silica-containing material and the wood fibers may be added in a powdered (dry) state, or may be also added after having mixed beforehand these starting materials with different water. The solids concentration of the slurry is adjusted to be not higher than 20 wt %. The rationale for setting the solids concentration of the slurry to be not higher than 20 wt % is that when the solids concentration exceeds 20 wt %, dewatering of the slurry takes time, cracks develop readily in the dewatered formed sheet, and sheet forming becomes difficult, among other problems.

The process of producing a formed sheet by dewatering the obtained slurry involves separating the slurry into water and a solid product, using felt, a wire mesh or the like. As a dewatering method, for instance, the slurry can be caused to flow down onto felt, to dewater thus the slurry. Alternatively, the slurry can be passed through a wire mesh.

The step of producing a laminated mat is accomplished by laminating another formed sheet on the obtained formed sheet. The method of laminating the formed sheets may involve, for instance, providing a plurality of devices for producing a formed sheet, along the transport direction of the formed sheet, and laminating formed sheets produced in each device, or may involve laminating a formed sheet by taking up the formed sheet on a roll, and removing the resulting sheet from the roll once a predetermined thickness is achieved.

The method of forming a rugged pattern on the obtained laminated mat, followed by curing, is accomplished by pressing the laminated mat at a pressure ranging from 1 to 10 MPa, followed by primary curing at 60 to 90° C. for 5 to 10 hours, and, thereafter, natural curing, steam curing or autoclave curing. The rugged pattern is formed on the surface of the laminated mat by placing a formboard on or under the laminated mat, during pressing. The autoclave curing conditions include curing for 7 to 15 hours at a temperature of 120° C. or higher, a pressure of 0.5 MPa or higher.

Examples of the present invention are explained next. Thinning wood was pulverized to produce wood flour having an average size of 1.0 mm, and the obtained wood flour was added to water. Next, defective wood cement boards after hardening were pulverized to an average particle size of 100 μm, and the obtained pulverized product of wood cement boards was added to the water having added thereto the wood flour, with mixing for 60 seconds. The solids concentration in the water was 15 wt %. To the water thus obtained there were added Portland cement, blast furnace slag, perlite, needle-leaves-tree unbleached kraft pulp having a Canadian freeness of 500 ml, used paper and different water, with mixing, to yield a slurry. The proportion of each starting material with respect to the total solids of the slurry was as in Table 1. The solids concentration of the slurry was 15 wt %. The slurry was caused to flow down onto a dewatering felt, on which a formed sheet was shaped accompanying dewatering. The formed sheet was taken up on a roll, up to six layers, to yield a laminated mat. The laminated mat was pressed under a press pressure of 2.5 MPa and for a press time of 7 seconds, whereby a 4 mm-deep block pattern having an angle of 55° was formed on the surface. This was followed by steam curing at 70° C., to yield a wood cement board according to Example 1.

To obtain a wood cement board of Example 2, a wood cement board was produced by setting the addition amount of wood flour to 2 wt % with respect to total solids, and by reducing proportionally the amount used paper to offset the increase in wood flour. All the wood flour was added initially to water. The proportions of the various starting materials with respect to the total solids of the slurry were as given in Table 1. Otherwise, conditions were identical to those of Example 1.

To obtain a wood cement board of Example 3, a wood cement board was produced by modifying the addition amount of pulverized product of wood cement board. The proportions of the various starting materials with respect to the total solids of the slurry were as given in Table 1. All the pulverized product of wood cement boards was added to the water after the wood flour. Otherwise, conditions were identical to those of Example 1.

To obtain a wood cement board of Example 4, a wood cement board was produced by adding the pulverized product of wood cement boards, and adding next the wood flour. All the pulverized product of wood cement boards was added to the water before the wood flour. The proportions of the various starting materials with respect to the total solids of the slurry were as given in Table 1. Otherwise, conditions were identical to those of Example 1.

To obtain a wood cement board of Example 5, a wood cement board was produced by changing the defective wood cement boards after hardening into defective wood cement boards before hardening. The defective wood cement boards before hardening that were used had been pulverized also to an average particle size of 100 μm. The proportions of the various starting materials with respect to the total solids of the slurry were as given in Table 1. Otherwise, conditions were identical to those of Example 1.

To obtain a wood cement board of Example 6, a wood cement board was produced by modifying the addition amount of wood flour to 2 wt % with respect to total solids. All the wood flour was added initially to water. The proportions of the various starting materials with respect to the total solids of the slurry were as given in Table 1. Otherwise, conditions were identical to those of Example 5.

To obtain a wood cement board of Example 7, a wood cement board was produced by using water obtained by dewatering a slurry as the water to which the wood flour was added to and mixed with, by changing the solids concentration in the water to 4 wt %, and by adding the pulverized product of wood cement boards at the same timing as that of the other starting materials. The proportions of the various starting materials with respect to the total solids of the slurry were as given in Table 1. Otherwise, conditions were identical to those of Example 1.

To obtain a wood cement board of Example 8, a wood cement board was produced by modifying the addition amount of wood flour to 2 wt % with respect to total solids. All the wood flour was added initially to the water resulting from dewatering a slurry. The proportions of the various starting materials with respect to the total solids of the slurry were as given in Table 1. Otherwise, conditions were identical to those of Example 7.

After adding wood flour to water, an amount of Portland cement double to that of the wood flour was further added, and the whole was mixed for 60 seconds. The solids concentration in the water was 10 wt %. Thereto were then added a pulverized product of wood cement boards having an average particle size of 100 μm, obtained through crushing of defective wood cement boards after hardening, plus Portland cement, blast furnace slag, perlite, needle-leaves-tree unbleached kraft pulp having a Canadian freeness of 500 ml, used paper, and a different water, with mixing to yield a slurry. Specifically, Portland cement was added together with the wood flour, and was further added also during production of the slurry. The proportions of the various starting materials with respect to the total solids of the slurry were as given in Table 1. Otherwise, a wood cement board was produced under the same conditions as in Example 1, to yield a wood cement board of Example 9.

Portland cement, blast furnace slag, perlite, needle-leaves-tree unbleached kraft pulp having a Canadian freeness of 500 ml, used paper and a pulverized product of wood cement boards after hardening were added to water, with mixing, to yield a slurry containing no wood flour. The proportion of each starting material with respect to the total solids of the slurry was as in Table 1. The solids concentration of the slurry was 15 wt %. A wood cement board was produced by treating the obtained slurry under the same conditions as in Examples 1 to yield a wood cement board of Comparative example 1.

To obtain a wood cement board of Comparative example 2, a wood cement board was produced under the same conditions as in Example 1, but herein all the other starting materials were added immediately after addition of the wood flour. The proportions of the various starting materials with respect to the total solids of the slurry were as given in Table 1.

To obtain a wood cement board of Comparative example 3, a wood cement board was produced under the same conditions as in Comparative example 2, but herein the addition amount of wood flour was 2 wt % with respect to total solids, and the amount of used paper was proportionally reduced to offset the increase in wood flour. All the wood flour was added initially to water. The proportions of the various starting materials with respect to the total solids of the slurry were as given in Table 1.

To obtain a wood cement board of Comparative example 4, a wood cement board was produced under the same conditions as in

Example 2, but herein the solids concentration of the water comprising the pulverized product of wood cement boards and the wood flour was changed to 2 wt %. The proportions of the various starting materials with respect to the total solids of the slurry were as given in Table 1.

To yield a wood cement board of Comparative example 5, a wood cement board was produced under the same conditions as in Example 2, but herein the size of the wood flour was changed to an average of 2.0 mm. The proportions of the various starting materials with respect to the total solids of the slurry were as given in Table 1.

Specific gravity, thickness, flexural strength and long-term durability were measured for the wood cement boards obtained in Examples 1 to 9 and Comparative examples 1 to 5, and the plasticity of the surface of the wood cement boards was also assessed. The results are given in Table 1. Flexural strength was measured in accordance with JIS A 1408. To evaluate long-term durability, a cycle of evaluation was employed in which an end of a 30 cm square wood cement board was immersed in water for 4 hours, was then placed in a sealed container filled with carbon dioxide for 4 hours, and was thereafter dried at 80° C. for 16 hours. This cycle was repeated 10 times, after which the state of the wood cement board was checked. Warpage smaller than 0.5 mm was rated as “good” (O), warpage ranging from 0.5 to 1.0 mm was rated as “fair” (A) and warpage of 1.0 mm or greater was rated as “poor” (x). To assess surface plasticity, the state of a block pattern formed on the surface of each wood cement board was checked. Absence of cracks was rated as “good” (O), while presence of cracks was rated as “poor” (x).

TABLE 1

| | | | Ex. 1 | Ex. 2 | Ex. 3 | Ex. 4 | Ex. 5 | Ex. 6 | Ex. 7 |
|---|---|---|---|---|---|---|---|---|---|
| Slurry | Wood flour | wt % | 1.0% | 2.0% | 1.0% | 1.0% | 1.0% | 2.0% | 1.0% |
| composition | Crushed product of | wt % | 9.7% | 9.7% | 17.7% | 9.7% | | | 9.7% |
| | wood cement boards | | | | | | | | |
| | after hardening | | | | | | | | |
| | Crushed product of | wt % | | | | | 9.7% | 9.7% | |
| | wood cement boards | | | | | | | | |
| | before hardening | | | | | | | | |
| | Needle-leaves-tree | wt % | 3.9% | 3.9% | 3.5% | 3.9% | 3.9% | 3.9% | 3.9% |
| | unbleached kraft | | | | | | | | |
| | pulp | | | | | | | | |
| | Used paper | wt % | 3.9% | 2.9% | 3.5% | 3.9% | 3.9% | 2.9% | 3.9% |
| | Portland cement | wt % | 33.0% | 33.0% | 30.1% | 33.0% | 33.0% | 33.0% | 33.0% |
| | Blast furnace slag | wt % | 38.8% | 38.8% | 35.4% | 38.8% | 38.8% | 38.8% | 38.8% |
| | Perlite | wt % | 9.7% | 9.7% | 8.8% | 9.7% | 9.7% | 9.7% | 9.7% |
| | Sub-total | wt % | 100.0% | 100.0% | 100.0% | 100.0% | 100.0% | 100.0% | 100.0% |
| Solids | Water in the step of | wt % | 15% | 15% | 15% | 15% | 15% | 15% | 4% |
| concentration | covering wood flour | | | | | | | | |
| | with calcium | | | | | | | | |
| | Slurry | wt % | 15% | 15% | 15% | 15% | 15% | 15% | 15% |
| Average size of wood flour | | mm | 1.0 | 1.0 | 1.0 | 1.0 | 1.0 | 1.0 | 1.0 |
| Properties | Specific gravity | | 1.01 | 1.03 | 1.02 | 1.01 | 1.03 | 1.01 | 1.03 |
| | Thickness | | 14.2 | 14.1 | 13.9 | 13.9 | 14.0 | 14.1 | 14.2 |
| | Flexural strength | N/mm² | 12.2 | 11.5 | 11.8 | 11.9 | 12.1 | 11.8 | 11.9 |
| | Long-term | | ◯ | ◯ | ◯ | ◯ | ◯ | ◯ | ◯ |
| | durability | | | | | | | | |
| | Surface plasticity | | ◯ | ◯ | ◯ | ◯ | ◯ | ◯ | ◯ |
| | | | | | Comp. | Comp. | Comp. | Comp. | Comp. |
| | | | Ex. 8 | Ex. 9 | ex. 1 | ex. 2 | ex. 3 | ex. 4 | ex. 5 |
| Slurry | Wood flour | wt % | 2.0% | 1.0% | | 1.0% | 2.0% | 2.0% | 2.0% |
| composition | Crushed product of | wt % | 9.7% | 9.5% | 9.7% | 9.7% | 9.7% | 9.7% | 9.7% |
| | wood cement boards | | | | | | | | |
| | after hardening | | | | | | | | |
| | Crushed product of | wt % | | | | | | | |
| | wood cement boards | | | | | | | | |
| | before hardening | | | | | | | | |
| | Needle-leaves-tree | wt % | 3.9% | 3.8% | 3.9% | 3.9% | 3.9% | 3.9% | 3.9% |
| | unbleached kraft | | | | | | | | |
| | pulp | | | | | | | | |
| | Used paper | wt % | 2.9% | 3.8% | 4.9% | 3.9% | 2.9% | 2.9% | 2.9% |
| | Portland cement | wt % | 33.0% | 34.3% | 33.0% | 33.0% | 33.0% | 33.0% | 33.0% |
| | Blast furnace slag | wt % | 38.8% | 38.1% | 38.8% | 38.8% | 38.8% | 38.8% | 38.8% |
| | Perlite | wt % | 9.7% | 9.5% | 9.7% | 9.7% | 9.7% | 9.7% | 9.7% |
| | Sub-total | wt % | 100.0% | 100.0% | 100.0% | 100.0% | 100.0% | 100.0% | 100.0% |
| Solids | Water in the step of | wt % | 4% | 10% | — | — | — | 2% | 15% |
| concentration | covering wood flour | | | | | | | | |
| | with calcium | | | | | | | | |
| | Slurry | wt % | 15% | 15% | 15% | 15% | 15% | 15% | 15% |
| Average size of wood flour | | mm | 1.0 | 1.0 | — | 1.0 | 1.0 | 1.0 | 2.0 |
| Properties | Specific gravity | | 1.02 | 1.01 | 1.02 | 1.00 | 0.96 | 0.97 | 0.97 |
| | Thickness | | 14.3 | 14.2 | 14.1 | 14.3 | 14.8 | 14.7 | 14.6 |
| | Flexural strength | N/mm² | 11.7 | 12.1 | 12.5 | 10.3 | 8.8 | 9.4 | 9.5 |
| | Long-term | | ◯ | ◯ | Δ | X | X | X | X |
| | durability | | | | | | | | |
| | Surface plasticity | | ◯ | ◯ | X | X | X | X | X |

The wood cement boards of Examples 1 to 9, which exhibited excellent flexural strength as well as “good” (O) long-term durability and surface plasticity, were thus superior in long-term durability and surface plasticity.

By contrast, the wood cement board of Comparative example 1, containing no wood flour, had “fair” (A) long-term durability and “poor” (x) surface plasticity, and was thus inferior in long-term durability and surface plasticity.

The wood cement board of Comparative example 2, in which other starting materials were added immediately after addition of the wood flour, had lower flexural strength and had “poor” long-term durability and surface plasticity, as compared with the wood cement board of Example 1 having an identical composition. The wood cement board of Comparative example 2 was thus inferior in long-term durability and surface plasticity. This trend was seen also in Comparative example 3, where the addition amount of wood flour was changed to 2 wt % with respect to total solids. Specifically, the wood cement board of Comparative example 3 had lower flexural strength, as compared with the wood cement board of Example 2 having an identical composition, and had “poor” (x) long-term durability and surface plasticity. The wood cement board of Comparative example 3 was thus inferior in long-term durability and surface plasticity.

The wood cement board of Comparative example 4, in which the solids concentration of water comprising a pulverized product of wood cement boards and wood flour was set to 2 wt %, had lower flexural strength, as compared with the wood cement board of Example 2 having an identical composition, and had “poor” long-term durability and surface plasticity. The wood cement board of Comparative example 4 was thus inferior in long-term durability and surface plasticity.

The wood cement board of Comparative example 5, in which the size of wood flour was 2.0 mm in average had lower flexural strength, as compared with the wood cement board of Example 2 having an identical composition, and had “poor” (x) long-term durability and surface plasticity. The wood cement board of Comparative example 5 was thus inferior in long-term durability and surface plasticity.

Embodiments of the present invention have been explained above, but the present invention is not limited thereto, and may accommodate all manner of variations within the scope of the invention as set forth in the appended claims.

As explained above, the present invention succeeds in providing a wood cement board that can be manufactured even at a press pressure not higher than 10 MPa, and that boasts excellent surface designability, flexural strength and long-term durability, and in providing a production method of such a wood cement board.

What is claimed is:

1. A wood cement board having on a surface thereof a rugged pattern,
the board comprising:
a plurality of layers laminated each having a cement, a silica-containing material, wood fibers and wood flour, wherein the cement and the silica-containing material are contained at a weight ratio ranging from 3:7 to 7:3;
the wood flour ranges in size from 0.3 to 1.5 mm and is covered with calcium; and
the content of the wood fibers and the wood flour is not greater than 9 wt % with respect to the total solids of the wood cement board.

2. The wood cement board according to claim 1, wherein the content of the wood flour ranges from 1 to 3 wt % with respect to the total solids of the wood cement board.

3. A method of producing a wood cement board,
the method comprising the steps of:
covering wood flour with calcium;
producing a slurry by mixing the thus-obtained wood flour, a cement, a silica-containing material and wood fibers;
producing a formed sheet by dewatering the thus-obtained slurry;
producing a laminated mat by laminating the thus-obtained formed sheet; and
pressing the obtained laminated mat at a pressure not higher than 10 MPa, forming thereby a rugged pattern, and performing curing, wherein
the step of covering wood flour with calcium is accomplished by adding to water a pulverized material of a cement composition and wood flour ranging in size from 0.3 to 1.5 mm, thereby being mixed at a solids concentration of 8 to 20 wt %; and
in the step of producing a slurry, the weight ratio of the cement and the silica-containing material in the slurry ranges from 3:7 to 7:3, and the amount of wood fibers and wood flour is not greater than 9 wt % with respect to total solids.

4. A method of producing a wood cement board,
the method comprising the steps of:
covering wood flour with calcium;
producing a slurry by mixing the thus-obtained wood flour, a cement, a silica-containing material and wood fibers;
producing a formed sheet by dewatering the thus-obtained slurry;
producing a laminated mat by laminating the thus-obtained formed sheet; and
pressing the thus-obtained laminated mat at a pressure not higher than 10 MPa, forming thereby a rugged pattern, and performing curing, wherein
the step of covering wood flour with calcium is accomplished by adding to water a cement and wood flour ranging in size from 0.3 to 1.5 mm, thereby being mixed at a solids concentration ranging from 3 to 10 wt %, and
in the step of producing a slurry, the weight ratio of the cement and the silica-containing material in the slurry ranges from 3:7 to 7:3, and the amount of the wood fibers and the wood flour is not greater than 9 wt % with respect to total solids.

5. A method of producing a wood cement board, the method comprising the steps of:
covering wood flour with calcium;
producing a slurry by mixing the thus-obtained wood flour, a cement, a silica-containing material and wood fibers;
producing a formed sheet by dewatering the thus-obtained slurry;
producing a laminated mat by laminating the thus-obtained formed sheet; and
pressing the thus-obtained laminated mat at a pressure not higher than 10 MPa, forming thereby a rugged pattern, and performing curing, wherein
the step of covering wood flour with calcium is accomplished by adding to water resulting from dewatering a slurry wood flour ranging in size from 0.3 to 1.5 mm, thereby being mixed at a solids concentration ranging from 3 to 10 wt %, and in the step of producing a slurry, the weight ratio of the cement and the silica-containing material in the slurry ranges from 3:7 to 7:3, and the amount of the wood fibers and the wood flour is not greater than 9 wt % with respect to total solids.

6. The method of producing wood cement board according to any of claims 3 to 5, wherein the amount of the wood flour ranges from 1 to 3 wt % with respect to the total solids of the wood cement board.

7. The method of producing wood cement board according to claim 3, wherein in the step of covering wood flour with calcium, the weight ratio of the wood flour and the pulverized material of the cement composition ranges from 1:7 to 1:20.

8. The method of producing wood cement board according to claim 3, wherein the cement composition is a wood cement board.

9. The method of producing wood cement board according to claim 4, wherein in the step of covering wood flour with calcium, the amount of the cement is greater than the amount of the wood flour.
